(19) United States
(12) Patent Application Publication
(10) Pub. No.: US 2026/0365038 A1
(43) Pub. Date: Nov. 19, 2026

(54) ELECTRIFIED VEHICLE AND A COASTING CONTROL METHOD THEREOF

(71) Applicants: HYUNDAI MOTOR COMPANY, Seoul (KR); KIA CORPORATION, Seoul (KR)

(72) Inventors: Jun Yong Park, Hwaseong-si (KR); Jun Haeng Heo, Hwaseong-si (KR); Tae Kyun Kim, Hwaseong-si (KR); Seong Joo Kim, Hwaseong-si (KR); Kyu hwan Jo, Hwaseong-si (KR); Seo Yeon Kim, Hwaseong-si (KR)

(73) Assignees: HYUNDAI MOTOR COMPANY, Seoul (KR); KIA CORPORATION, Seoul (KR)

(21) Appl. No.: 19/228,199

(22) Filed: Jun. 4, 2025

(30) Foreign Application Priority Data
Nov. 15, 2024 (KR) 10-2024-0163420

(51) Int. Cl. B60L 15/20

(52) U.S. Cl. CPC B60L 15/2045; B60L 2240/12; B60L 2240/423

(57) ABSTRACT

An electrified vehicle and a method for controlling the coasting operation of the vehicle. The electrified vehicle includes a drive unit having a motor configured to drive the vehicle, and a controller. Based on determination of a deceleration required point on a traveling path of the vehicle, the controller is configured to control a coasting torque of the drive unit to ensure that the vehicle speed at the deceleration required point follows a target speed. The controller is further configured to, upon satisfaction of a feedback control entry condition during the coasting torque control, control the coasting torque based on a feedback torque command.

### CROSS REFERENCE TO RELATED APPLICATION

This application claims priority to Korean Patent Application No. 10-2024-0163420, filed Nov. 15, 2024, the entire contents of which are incorporated herein by reference.

### BACKGROUND

### Field

The disclosure relates to an electrified vehicle and a coasting torque-based coasting control method thereof.

### Description of the Related Art

Automakers are developing various technologies to improve energy efficiency, including vehicle power efficiency and fuel efficiency. To enhance energy efficiency, it is essential to develop technologies that enable vehicles to maximize travel distance with minimal energy consumption during deceleration, in addition to improving acceleration efficiency.

One of the technologies applicable for improving efficiency during deceleration is coasting operation, a driving mode in which the vehicle gradually decelerates using its kinetic energy without applying acceleration input, such as when the accelerator pedal is not operated. During coasting operation, braking is not necessarily required to reduce the vehicle speed, thereby improving the vehicle's energy efficiency during driving.

Furthermore, in electrified vehicles such as hybrids and electric vehicles, which use motors as power sources, controlling coasting torque via the motor is relatively straightforward, allowing for enhanced coasting performance through precise torque control.

The statements in this Background section merely provide background information related to the present disclosure and may not constitute prior art.

### SUMMARY

The disclosure provides an electrified vehicle and a coasting control method thereof that are capable of enhancing coasting performance through the control of coasting torque.

The objects of the disclosure are not limited to the aforesaid, and other objects not described herein should be clearly understood by those having ordinary skill in the art from the descriptions below.

According to an embodiment of the disclosure, an electrified vehicle includes: a drive unit including a motor configured to drive the vehicle, and a controller configured to control, based on determination of a deceleration required point on a traveling path of the vehicle, a coasting torque of the drive unit such that the vehicle speed at the deceleration required point follows a target speed at the deceleration required point. The controller is further configured to control the coasting torque based on a feedback torque command upon the satisfaction of a feedback control entry condition during the coasting torque control.

In another embodiment of the present disclosure, a method for controlling a coasting operation of an electrified vehicle, including a drive unit with a motor for driving the vehicle, includes: based on determining a deceleration required point on a traveling path of the vehicle, controlling a coasting torque of the drive unit such that a vehicle speed at the deceleration required point follows a target speed at the deceleration required point. The method further includes upon satisfying a feedback control entry condition during the coasting torque control, performing feedback control to adjust the coasting torque based on a feedback torque command.

Various embodiments of the disclosure are advantageous in terms of improving the target vehicle speed tracking performance during coasting, as the vehicle coasts in a deceleration situation using the optimal coasting torque to satisfy the target speed.

Moreover, as the target speed tracking performance during coasting improves, the need for additional braking interventions during deceleration is reduced, thereby enhancing the convenience of vehicle operation.

The advantages of the disclosure are not limited to the aforesaid, and other advantages not described herein may be clearly understood by those having ordinary skill in the art from the descriptions below.

### BRIEF DESCRIPTION OF THE DRAWINGS

FIG. 1 is a block diagram illustrating the configuration of an electrified vehicle according to an embodiment of the disclosure;

FIG. 2 is a block diagram illustrating the configuration of a controller of an electrified vehicle according to an embodiment of the disclosure;

FIGS. 3 to 5 are time-series diagrams illustrating the control process during coasting operation according to an embodiment of the disclosure; and

FIG. 6 is a flowchart illustrating the coasting control method according to an embodiment of the disclosure.

The drawings described herein are for illustration purposes only and are not intended to limit the scope of the present disclosure in any way.

### DETAILED DESCRIPTION

The specific structural or functional descriptions of the embodiments disclosed in the present disclosure or patent application are illustrative examples intended to describe embodiments of the disclosure, and the embodiments of the disclosure can be implemented in various forms and should not be construed as being limited to those described in the present disclosure or the application.

The embodiments of the disclosure can be subject to various modifications and can take on different forms, so specific embodiments are illustrated in the drawings and described in detail in the present disclosure or the application. However, this should not be construed as limiting the embodiments of the disclosure to specific disclosed forms, but rather should be understood to encompass all modifications, equivalents, or substitutes that fall within the scope of the concept and technological scope of the disclosure.

Unless otherwise defined, all terms used herein, including technical or scientific terminology, have the same meaning as commonly understood by those having ordinary skill in the art to which the disclosure belongs. It should be further understood that terms, including those defined in commonly used dictionaries, should be interpreted in a manner consistent with their meaning in the context of the relevant field and should not be interpreted in an idealized or overly formal sense unless explicitly defined in the present disclosure.

Hereinafter, descriptions are made of the embodiments disclosed in the present disclosure with reference to the accompanying drawings in which the same reference numbers are assigned to refer to the same or like components and redundant description thereof is omitted.

In the following description of the embodiments, the term “predetermined” means that the numerical values of parameters are established in advance when using the parameters in a process or algorithm. The numerical values of the parameters may be set at the beginning of the process or algorithm or may be established during the execution of the process or algorithm, depending on the embodiment.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

Detailed descriptions of known technologies may be omitted to avoid obscuring the subject matter of the embodiments disclosed in the present disclosure. In addition, the accompanying drawings are only for easy understanding of the embodiments disclosed in the present specification and do not limit the technical spirit disclosed herein, and it should be understood that the embodiments include all changes, equivalents, and substitutes within the spirit and scope of the disclosure.

As used herein, terms including an ordinal number such as “first” and “second” can be used to describe various components without limiting the components. The terms are used only for distinguishing one component from another component. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

It should be understood that when a component is referred to as being “connected to” or “coupled to” another component, it can be directly connected or coupled to the other component or intervening component may be present. In contrast, when a component is referred to as being “directly connected to” or “directly coupled to” another component, there are no intervening components present.

The singular forms are intended to include the plural forms as well unless the context clearly indicates otherwise.

It should be further understood that the terms “comprises” or “has,” when used in the present disclosure, specify the presence of a stated feature, number, step, operation, component, element, or a combination thereof, but they do not preclude the presence or addition of one or more other features, numbers, steps, operations, components, elements, or combinations thereof.

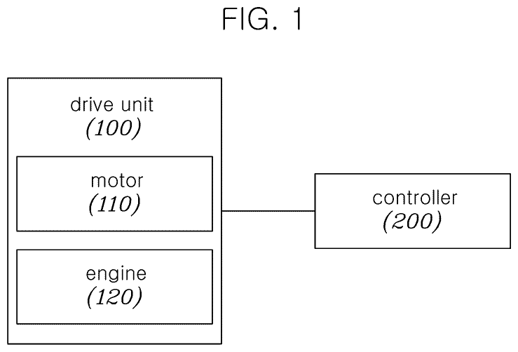

Before delving into the coasting control method for a vehicle, the electrified vehicle according to an embodiment is described with reference to FIG. 1.

FIG. 1 is a block diagram illustrating the configuration of an electrified vehicle according to an embodiment of the disclosure.

With reference to FIG. 1, the electrified vehicle according to an embodiment includes a drive unit 100 and a controller 200. However, FIG. 1 illustrates only the components relevant to the description of one embodiment, and an actual electrified vehicle may be implemented with more or fewer components.

The drive unit 100 includes a motor 110 and, in some embodiments, may further include an engine 120. For example, the electrified vehicle may be implemented as an electric vehicle (EV), in which the motor 110 serves as the sole power source, or as a hybrid electric vehicle (HEV), in which both the motor 110 and the engine 120 function as power sources.

According to an embodiment, the electrified vehicle may coast using the coasting torque from the drive unit 100, allowing deceleration without the need for separate braking interventions, such as operating the brake pedal. Furthermore, the electrified vehicle according to an embodiment may provide enhanced driving convenience through coasting under certain driving conditions.

Here, coasting is defined as a driving state in which the vehicle uses inertia without additional acceleration, such as when the accelerator pedal is not pressed, and may also be referred to as freewheeling. Coasting torque refers to the torque acting on the vehicle during coasting, and in an embodiment, the coasting torque is adjusted through the drive unit 100, enabling control of the vehicle deceleration.

In certain driving situations, including cases where a deceleration required point is detected or determined ahead on the vehicle's traveling path, the electrified vehicle according to an embodiment may decelerate through coasting from the detection point of the deceleration required point until the vehicle reaches the deceleration required point. In this case, the vehicle coasting is performed with the goal of ensuring that the vehicle speed at the deceleration required point meets the target speed at the deceleration required point. This allows for improved driving convenience in situations requiring deceleration, while also enhancing the vehicle's energy efficiency.

To achieve this, when a deceleration required point on a traveling path is detected or determined, the controller 200 may control the coasting torque of the drive unit 100 such that the vehicle speed upon reaching the deceleration required point matches the target speed at that point, particularly by adjusting the coasting torque of the motor 110 to control the vehicle's coasting operation.

Here, the deceleration required point may include at least one of the entry point of a road junction, the entry point of a speed limit zone, or the entry point of a curved road, and the target speed at each deceleration required point may be determined based on the predetermined classification of deceleration required point.

In an embodiment, the controller 200 is configured to generate a feedback torque command when the feedback control entry condition is satisfied during the control of the coasting torque as described above, and based on the feedback torque command, the coasting torque may be controlled. This enhances the target speed tracking performance during coasting.

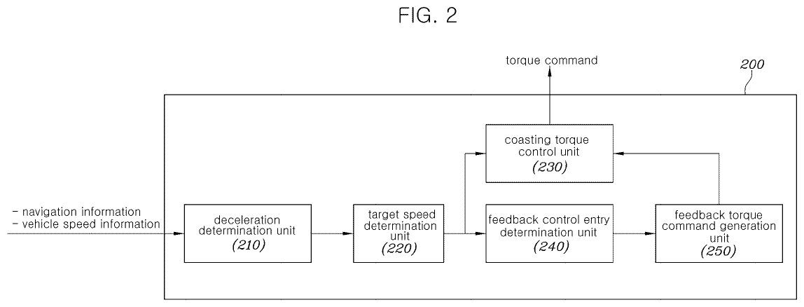

To further improve the target speed tracking performance during coasting, it is desired to optimally control the timing of feedback control intervention and the magnitude of the feedback torque command. The operations performed by the controller 200 in this regard are described with reference to FIG. 2 below.

FIG. 2 is a block diagram illustrating the configuration of a controller of an electrified vehicle according to an embodiment of the disclosure.

In the embodiment of FIG. 2, the controller 200 may include a deceleration determination unit 210, a target speed determination unit 220, a coasting torque control unit 230, a feedback control entry determination unit 240, and a feedback torque command generation unit 250. However, the components of the controller 200 described with reference to FIG. 2 are divided based on their functions for the convenience of explanation, and the implementation of the controller 200 is not necessarily limited thereto.

The deceleration determination unit 210 may detect a deceleration required point along the traveling path in the traveling direction of the vehicle based on the vehicle position information and road information.

In this case, the vehicle position information and road information associated with the vehicle's traveling path may be included in navigation data obtained from the navigation system installed in the vehicle. The vehicle position information may include, for example, global positioning system (GPS) coordinate data, while the road information may include details related to the road the vehicle is traveling on (e.g., roads on the traveling path), such as the location of road junctions, locations and speed limits of restricted speed zones, road curvature, and gradients.

The deceleration determination unit 210 may determine or detect deceleration required points based on input information, determining that a deceleration required point exists ahead on the traveling path or in the vehicle traveling direction when the input information satisfies predetermined conditions for each deceleration required point.

However, depending on the implementation, the controller 200 may not include the deceleration determination unit 210, and in this case, may obtain information about deceleration required points determined externally. According to an embodiment, deceleration required points may be input through the vehicle operation by the user, such as the driver.

The target speed determination unit 220 may determine the target speed at the detected (or determined) deceleration required point. In this case, the target speed may be determined based on the type or predetermined classifications of deceleration required point(s), and when multiple deceleration required points are determined, the target speed may be determined according to the priority among the deceleration required points.

For example, the priority among multiple deceleration required points may be determined based on their respective target speeds, wherein lower target speeds are assigned higher priority. In this case, the target speed determination unit 220 may use the target speed of the deceleration required point with the highest priority (i.e., the lowest target speed) as the reference for target speed tracking during coasting.

Once the target speed to be tracked is determined, the coasting torque control unit 230 controls the coasting torque of the drive unit 100 to track the target speed.

In an embodiment, the coasting torque control unit 230 may generate a feedforward torque command based on the speed error between the vehicle speed and the target speed at the start point of coasting torque control, and control the coasting torque of the drive unit 100 according to the feedforward torque command. For example, the coasting torque control unit 230 may generate a feedforward torque command with a larger magnitude when the speed error between the vehicle speed and the target speed is greater at the time of starting the coasting torque control.

Here, the control of the coasting torque may begin when a deceleration required point is detected or determined, but is not limited thereto; it may start after the deceleration required point is detected and before reaching the deceleration required point.

The feedback control entry determination unit 240 may determine whether feedback control entry condition is satisfied during the control of coasting torque.

More specifically, the feedback control entry determination unit 240 may determine that the feedback control entry condition is satisfied when the remaining distance to the deceleration required point is less than or equal to a reference distance.

In this case, the reference distance may be determined based on the speed error between the vehicle speed and the target speed at the start of coasting torque control, and may have a positive correlation with the speed error.

For example, the reference distance may be expressed as a predetermined percentage of the total deceleration distance between the coasting torque control start point and the deceleration required point, and the percentage of the total deceleration distance may be determined based on the speed error. Additionally, in determining the reference distance, the feedback control entry determination unit 240 may refer to a table that takes the speed error as input and outputs a predetermined percentage of the total deceleration distance.

It is also possible to further consider the aforementioned vehicle position information and road information in determining the reference distance. In this case, the road information may include the road gradient, and the feedback control entry determination unit 240 may adjust the reference distance, initially derived based on the speed error, according to the road gradient ahead of the vehicle, ultimately determining the reference distance. For example, the feedback control entry determination unit 240 may adjust the reference distance to be shorter when the road gradient ahead is steeper.

When the feedback control entry condition is satisfied, the feedback torque command generation unit 250 may generate a feedback torque command for controlling the coasting torque. In this case, the feedback torque command generation unit 250 may generate a feedback torque command based on the deceleration error between the target deceleration and the vehicle's current deceleration.

The target deceleration, which is the target value for deceleration tracking at each control sequence, may be determined based on at least one of the vehicle's current speed, target speed, or the remaining distance to the deceleration required point.

For example, the feedback torque command generation unit 250 may determine the target deceleration as the value based on (current speed−target speed)/(remaining distance/current speed), and based on the determined target deceleration and the deceleration error between the target and current decelerations, the value of the feedback torque command may be determined.

According to an embodiment, the vehicle's current deceleration may be obtained through an acceleration sensor installed in the vehicle, and for example, the output signal from the acceleration sensor may be filtered using a low-pass filter (LPF) or the like, with the filtered value being used as the vehicle's current deceleration.

The feedback torque command generation unit 250 may generate a feedback torque command by applying a gain value to the deceleration error between the target deceleration and the current deceleration, and the generated feedback torque command is applied to the coasting torque control unit 230.

The coasting torque control unit 230 initially controls the coasting torque based on the feedforward torque command as described above, but when the feedback control entry condition is satisfied and the feedback torque command is applied, the coasting torque control is switched based on the feedback torque command, instead of the feedforward torque command, to control the coasting torque of the drive unit 100.

To control these functions, the controller 200 may include a communication device for communicating with other controllers or sensors, a memory for storing the operating system, logic instructions, and input/output information, and one or more processors for performing the judgment, calculation, and decision-making necessary for controlling the assigned functions.

Additionally, the controller 200 may be implemented, for example, as a motor control unit (MCU), a hybrid control unit (HCU), or a vehicle control unit (VCU), but may also be implemented in other forms, such as a separate controller, a combination of two or more controllers, or as a single function of any of the controllers. It should be noted that the terms ‘unit’ or ‘control unit’ used in the names of components typically refer to controllers responsible for specific vehicle functions, rather than indicating a generic function unit.

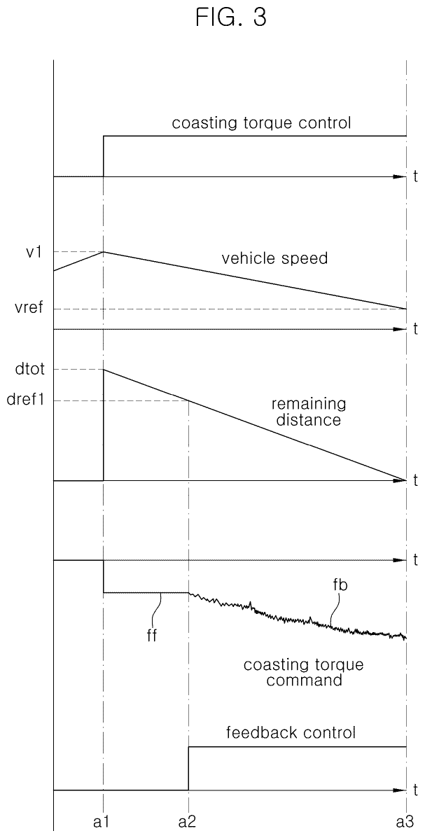

Hereinafter, a description of the overall control process according to an embodiment is provided with reference to FIGS. 3 to 5.

FIGS. 3 to 5 are time-series diagrams illustrating the control process during coasting operation according to an embodiment of the disclosure.

FIG. 3 illustrates the execution of coasting torque control, vehicle speed, remaining distance, coasting torque command, and the execution of feedback control during the coasting operation control process, from the start of coasting torque control upon detecting the deceleration required point at time a1 until the vehicle reaches the deceleration required point at time a3.

When coasting torque control begins at time a1, the controller 200 adjusts the coasting torque to control the coasting operation and ensure that the vehicle speed at the deceleration required point follows the target speed vref, during the initial phase (a1-a2), before the feedback control entry condition is met, the coasting torque is controlled based on the feedforward torque command ff.

When the remaining distance becomes less than or equal to the reference distance dref1 and the feedback control condition is met, the controller 200 controls the coasting torque based on the feedback torque command fb from that point until the vehicle reaches the deceleration required point (a2-a3).

Additionally, the controller 200 may apply different entry points for feedback control depending on the vehicle's driving conditions and, to do so, may variably apply the reference distance that serves as the criterion for determining entry into feedback control.

For example, when the target speed is vref and the vehicle speed at the start of coasting torque control is v1, the reference distance dref1 may be determined as 70% of the total deceleration distance dtot.

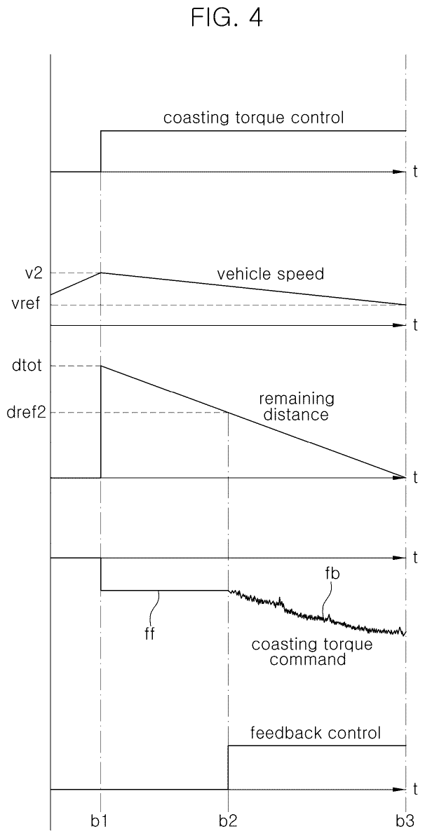

FIG. 4 illustrates an example where the vehicle speed at the start of coasting torque control is v2 (<v1), under the same conditions of target speed vref and total deceleration distance dtot.

In this case, since the speed error between the vehicle speed at the start of coasting torque control v2 and the target speed vref is smaller compared to the case in FIG. 3, the reference distance dref2 may be smaller than the reference distance dref1 in FIG. 3. For example, in this case, the reference distance dref2 may be determined as 60% of the total deceleration distance dtot, and as a result, the time (b1-b2) between the start of coasting torque control and the execution of feedback control may be longer compared to the case in FIG. 3 (a1-a2), leading to a relatively later entry into feedback control.

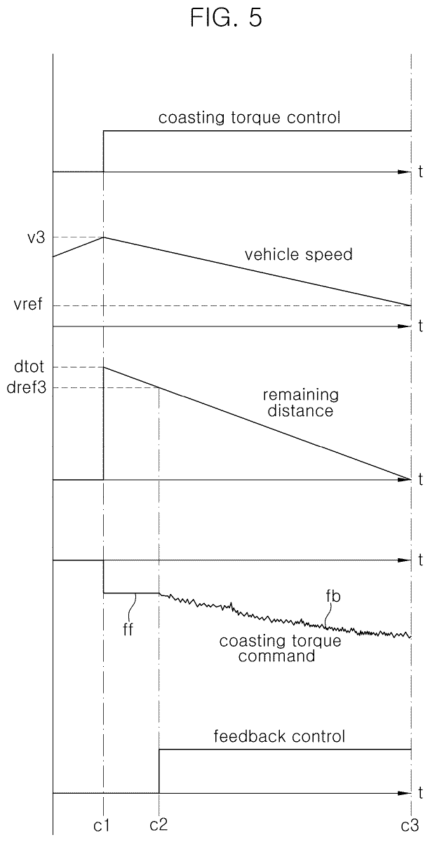

FIG. 5 illustrates an example where the vehicle speed at the start of coasting torque control is v3 (>v1) under the same conditions of target speed vref and total deceleration distance dtot.

In this case, since the speed error between the vehicle speed at the start of coasting torque control v3 and the target speed vref is larger compared to the case in FIG. 3, the reference distance dref3 may be larger than the reference distance dref1 in FIG. 3. For example, in this case, the reference distance dref3 may be determined as 80% of the total deceleration distance dtot, and as a result, the time (c1-c2) between the start of coasting torque control and the execution of feedback control may be shorter compared to the case in FIG. 3 (a1-a2), leading to a relatively quicker entry into feedback control.

The following elaborates on the coasting operation control process with reference to a flowchart.

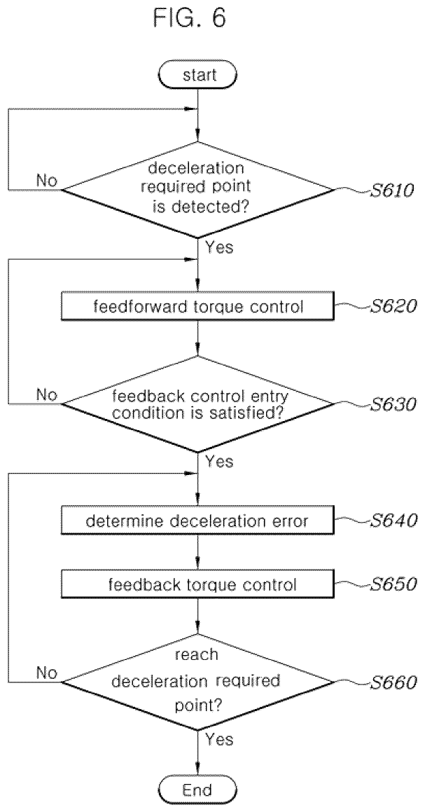

FIG. 6 is a flowchart illustrating the coasting control method according to an embodiment of the disclosure.

With reference to FIG. 6, the controller 200 detects or determines the deceleration required point (Yes in operation S610) on the vehicle's traveling path, and then controls the vehicle's coasting operation by adjusting the coasting torque, initially performing torque control in a feedforward manner in operation S620 based on the vehicle speed and target speed at the start of coasting torque control.

During the coasting torque control, in operation S630, the controller 200 determines the entry point for feedback control by assessing whether the feedback control entry conditions are met, and when these conditions are satisfied (Yes in operation S630), such as when the remaining distance to the deceleration required point becomes less than or equal to the reference distance, the controller may enter feedback control.

When performing feedback control, the controller 200 determines the deceleration error between the vehicle's current deceleration and the target deceleration in operation S640, and based on this, performs feedback control of the coasting torque based on the generated feedback torque command in operation S650. Subsequently, when the vehicle reaches the deceleration required point (Yes in operation S660), the coasting operation control process ends.

Various embodiments of the disclosure are advantageous in terms of improving the target vehicle speed tracking performance during coasting, as the vehicle coasts in a deceleration situation using the optimal coasting torque to satisfy the target speed.

Moreover, as the target speed tracking performance during coasting improves, the need for additional braking interventions during deceleration is reduced, thereby enhancing the convenience of vehicle operation.

Although the disclosure has been illustrated and described in connection with specific embodiments, it should be obvious to those having ordinary skill in the art that various modification and changes can be made thereto without departing from the scope of the disclosure that is defined by the appended claims.

What is claimed is:

1. An electrified vehicle including:
a drive unit including a motor configured to drive the electrified vehicle; and
a controller configured to:
based on determination of a deceleration required point on a traveling path of the electrified vehicle, control a coasting torque of the drive unit such that a vehicle speed at the deceleration required point tracks a target speed at the deceleration required point, and
upon satisfaction of a feedback control entry condition while controlling the coasting torque, control the coasting torque based on a feedback torque command.

2. The electrified vehicle of claim 1, wherein the target speed is determined based on predetermined classification of the deceleration required point.

3. The electrified vehicle of claim 2, wherein when a plurality of deceleration required points is determined, the target speed is determined based on a deceleration required point with the lowest target speed among the plurality of determined deceleration required points.

4. The electrified vehicle of claim 1, wherein the feedback control entry condition is satisfied when a remaining distance to the deceleration required point is less than or equal to a reference distance determined based on a speed error between the target speed and a vehicle speed at a start point of coasting torque control.

5. The electrified vehicle of claim 4, wherein the reference distance has a positive correlation with the speed error.

6. The electrified vehicle of claim 4, wherein the reference distance is determined based on a gradient of a road ahead of the electrified vehicle based on location information of the electrified vehicle and road information associated with the traveling path.

7. The electrified vehicle of claim 1, wherein the feedback torque command is determined based on a target deceleration and a deceleration error, and
wherein the target deceleration is determined based on the target speed, and the deceleration error is a difference between a current deceleration of the electrified vehicle and the target deceleration.

8. The electrified vehicle of claim 7, wherein the target deceleration is determined based on the current vehicle speed, the target speed, and a remaining distance to the deceleration required point.

9. The electrified vehicle of claim 1, wherein the controller is configured to:
until the feedback control entry condition is satisfied, control the coasting torque of the drive unit based on a feedforward torque command determined based on a speed error between a vehicle speed at a start point of coasting torque control and the target speed, and
upon satisfaction of the feedback control entry condition, control the coasting torque of the drive unit based on the feedback torque command instead of the feedforward torque command.

10. The electrified vehicle of claim 1, wherein the controller is configured to determine the deceleration required point based on location information of the electrified vehicle and road information associated with the traveling path.

11. A method for controlling a coasting operation of an electrified vehicle including a drive unit with a motor for driving the electrified vehicle, the method including:
based on determining a deceleration required point on a traveling path of the electrified vehicle, controlling a coasting torque of the drive unit such that a vehicle speed at the deceleration required point tracks a target speed at the deceleration required point; and
upon satisfying a feedback control entry condition while controlling the coasting torque, performing feedback control to adjust the coasting torque based on a feedback torque command.

12. The method of claim 11, wherein the target speed is determined based on predetermined classification of the deceleration required point.

13. The method of claim 12, wherein upon determining a plurality of deceleration required points, the target speed is determined based on the deceleration required point with the lowest target speed among the plurality of determined deceleration required points.

14. The method of claim 11, wherein the feedback control entry condition is satisfied when a remaining distance to the deceleration required point is less than or equal to a reference distance determined based on a speed error between the target speed and a vehicle speed at a start point of coasting torque control.

15. The method of claim 14, wherein the reference distance has a positive correlation with the speed error.

16. The method of claim 14, wherein the reference distance is determined based on a gradient of a road ahead of the electrified vehicle based on location information of the electrified vehicle and road information associated with the traveling path.

17. The method of claim 11, wherein the feedback torque command is determined based on a target deceleration and a deceleration error, and
Wherein the target deceleration is determined based on the target speed, and the deceleration error is a difference between a current deceleration of the electrified vehicle and the target deceleration.

18. The method of claim 17, wherein the target deceleration is determined based on the current vehicle speed, the target speed, and a remaining distance to the deceleration required point.

19. The method of claim 11, wherein controlling the coasting torque comprises:
until the feedback control entry condition is satisfied, controlling the coasting torque of the drive unit based on a feedforward torque command determined based on a speed error between a vehicle speed at a start point of coasting torque control and the target speed, and
wherein performing the feedback control comprises: upon satisfaction of the feedback control entry condition, controlling the coasting torque of the drive unit based on the feedback torque command instead of the feedforward torque command.

20. The method of claim 11, further comprising: determining the deceleration required point based on location information of the electrified vehicle and road information associated with the traveling path.
